(19) United States
(12) Patent Application Publication
(10) Pub. No.: US 2012/0258855 A1
(43) Pub. Date: Oct. 11, 2012

(54) PROCESS FOR MANUFACTURING A CATALYST SUPPORT AND A CATALYST

(75) Inventors: Desmond Marinus Cornelis DEKKER, Amsterdam (NL); Gerardus Petrus Lambertus NIESEN, Amsterdam (NL); Daan VLAAR, Amsterdam (NL)

(73) Assignee: SHELL OIL COMPANY, Houston, TX (US)

(21) Appl. No.: 13/333,357

(22) Filed: Dec. 21, 2011

(30) Foreign Application Priority Data
Dec. 23, 2010 (EP) EP10196799.0

(51) Int. Cl. B01J 37/04; B01J 21/06; B01J 23/08; B01J 23/10; B01J 23/46; B01J 21/04; B01J 29/00; B01J 23/75; B01J 23/745; B01J 23/755; B01J 32/00; B01J 21/08

(52) U.S. Cl. 502/240; 502/439; 502/300; 502/325; 502/338; 502/337; 502/349; 502/355; 502/304; 502/350

(57) ABSTRACT

The invention relates to a process for manufacturing a catalyst support, in which one or more fibres are fed into a mould, said fibre having a diameter in the range of 5-300 microns, and a length over diameter ratio greater than 500. The body in the mould is compressed and then contacted with a mixture comprising a liquid and a carrier material. The liquid is removed from the wetted body to provide a catalyst support comprising an entangled fibre and carrier material. A catalyst can be made using the same process and additionally adding a catalytically active metal with the mixture comprising a liquid and a carrier material. Alternatively a catalyst can be made using the process for manufacturing a catalyst support followed by impregnation with a catalytically active metal.

This application claims the benefit of European Application No. 10196799.0, filed Dec. 23, 2010, which is incorporated herein by reference.

### BACKGROUND

This invention relates to a process for the manufacture of a catalyst support.

Many catalytic reactions are mass transfer-limited. For these reactions it is important that the reaction components have easy access to the catalytic sites, and that the reaction products can easily be removed from the catalytic sites. For these types of reactions catalyst accessibility is of prime importance.

One such example of mass transfer-limited catalytic reactions are the Fischer-Tropsch processes. These are often used for the conversion of gaseous hydrocarbon feed stocks into liquid and/or solid hydrocarbons. The feed stock, e.g. natural gas, associated gas, coal-bed methane, residual (crude) oil fractions, coal and/or biomass is converted in a first step to a mixture of hydrogen and carbon monoxide, also known as synthesis gas or syngas. The synthesis gas is then converted in a second step over a suitable catalyst at elevated temperature and pressure into paraffinic compounds ranging from methane to high molecular weight molecules comprising up to 200 carbon atoms, or, under particular circumstances, more.

Fisher-Tropsch catalysts have been used based on porous substrates. WO2006037776 describes the use of woven or non-woven metal structures in the shape of blankets, and porous catalyst elements based on gauze, sponge, foam, foil constructs, mesh, or webbing material.

It has been found that the wire structures used as catalyst substrates known in the art often have insufficient strength. Such insufficient strength may result in the constituent wires becoming detached from the substrate. These detached wires may lead to plugging of the catalytic reactor and other process problems downstream of the reactor holding the catalyst. Further, the known structures are difficult to obtain in different shapes, and depending on the nature of the material, they may be quite costly. For example, a substrate based on drawn wires is quite expensive due to the high cost of the starting material.

There is therefore a need for an improved coated structure which can be used as a catalyst substrate and allows the use of relatively inexpensive starting materials, the manufacturing of substrates in different shapes, and which provides catalyst substrates with good strength and porosity characteristics to aid mass transfer. In addition, for industrial applications, structures for use as catalyst substrates may be required in high production volumes, such that a high output manufacturing process is desirable and the means to manufacture such substrates in a variety of shapes. The present invention seeks to address these problems.

### SUMMARY OF THE INVENTION

In a first aspect, the present invention provides a coated structure, which is non-woven, comprising at least one entangled fibre with a diameter or equivalent diameter in the range of 5-300 microns, and a length over diameter ratio, or length over equivalent diameter ratio, greater than 500, wherein at least a portion of said fibre has a coating deposited thereon, said coating comprising a carrier material or a precursor of said carrier material.

In a further aspect, the present invention provides a process for manufacturing a coated structure according to the first aspect, the process comprising at least the steps of:

feeding at least one fibre into a mould to provide a body comprising the fibre, said fibre having a diameter or equivalent diameter in the range of 5-300 microns, and a length over diameter ratio, or a lenth over equivalent diameter ratio, greater than 500;

compressing the body in the mould to provide a compressed body comprising entangled fibre;

contacting at least a part of the compressed body with a mixture comprising (i) liquid and (ii) carrier material or a precursor of said carrier material to provide a wetted body; and

removing liquid from the wetted body to provide a coated structure comprising the entangled fibre and the carrier material or the precursor of said carrier material deposited on at least a portion of said fibre.

Contacting at least a part of the compressed body with a mixture comprising (i) liquid and (ii) carrier material or a precursor of said carrier material to provide a wetted body may be performed when the compressed body is still in the mould, or after the compressed body has been taken out of the mould.

In a still further aspect, the coated structure described herein may be a catalyst support.

In another aspect, the present invention provides a catalyst comprising the coated structure of the first aspect in which the coating comprises a catalytic material or a precursor thereof.

The present invention provides a process for manufacturing a catalyst, which comprises at least the steps of:

feeding at least one fibre into a mould to provide a body comprising the fibre, said fibre having a diameter or equivalent diameter in the range of 5-300 microns, and a length over diameter ratio, or length over equivalent diameter ratio, greater than 500;

compressing the body in the mould to provide a compressed body comprising entangled fibre;

contacting at least a part of the compressed body with a mixture comprising (i) liquid and (ii) carrier material or a precursor of said carrier material to provide a wetted body; and

removing liquid from the wetted body to provide a catalyst support comprising the entangled fibre and the carrier material or the precursor of said carrier material deposited on at least a portion of said fibre;

impregnating the obtained catalyst support with a catalytically active metal or a precursor of said catalytically active metal.

The present invention further provides a process for manufacturing a catalyst, which comprises at least the steps of:

feeding at least one fibre into a mould to provide a body comprising the fibre, said fibre having a diameter or equivalent diameter in the range of 5-300 microns, and a length over diameter ratio, or length over equivalent diameter ratio, greater than 500;

compressing the body in the mould to provide a compressed body comprising entangled fibre;

contacting at least a part of the compressed body with a mixture comprising (i) liquid, (ii) carrier material or a precursor of said carrier material and (iii) a catalytically active metal or a precursor of said catalytically active metal to provide a wetted body; and

removing liquid from the wetted body to provide a catalyst comprising the entangled fibre, the carrier material or the precursor of said carrier material and the catalytically active metal or the precursor of said catalytically active metal deposited on at least a portion of said fibre.

In yet another aspect, the present invention provides the use of a catalyst as described herein in a diffusion limited reaction.

### BRIEF DESCRIPTION OF THE DRAWINGS

FIG. 1 is a diagrammatic scheme of a method of, and apparatus for, the manufacture of a coated structure utilising robotic arms.

### DETAILED DESCRIPTION

The coated structure described herein has improved strength due to the connectivity between the constituent fibre and fibres and the range of the ratio of the average length to average diameter (also called ‘aspect ratio’) of its constituent fibre or fibres. By utilising a fibre having an aspect ratio of greater than 500, the loss of individual fibres from the structure can be reduced due to increased entanglement as a result of longer fibre length for a given diameter or equivalent diameter. Any substantial loss of component fibres from a coated structure may be disadvantageous, for instance because free fibres may obstruct or foul passageways or components such as valves or filters, particularly if the coated structure is used as a catalyst support in a catalytic reactor.

In the context of the present description, the term “entangled fibre” means a fibre having a plurality of coils or folds, typically overlapping, such as a fibre rolled or folded longitudinally upon itself. Such an entangled fibre is achieved, at least in part by the compression step disclosed herein. The entangled fibre may comprise one or more intersections at which different points along the length of the same fibre come into contact. The coating deposited upon at least a portion of the fibre may permanently secure such points at which the fibre meets.

The coated structure may comprise a plurality of said entangled fibres. Such entangled fibres can intersect not only at different points along the length of the same fibre but also at one or more points connecting different fibres. The coating deposited upon at least a portion of the entangled fibre or fibres may secure such points at which the fibre or fibres meet.

The coated structure and process of manufacturing such a structure and its advantages will be described in more detail below, as will be further aspects of the invention.

In one embodiment, a coated structure is provided. The coated structure comprises at least one entangled fibre, and is non-woven. In some circumstances, the coated structure may comprise a plurality of fibres. As used herein, the term ‘non-woven’ means that when the coated structure is formed from a plurality of fibres, these are not interlaced by weaving i.e. by interlacing sets of warp and weft fibres.

The nature of the fibre or fibres used herein may depend on the nature of the coated structure to be formed and any catalyst to be based upon it. The fibre should be such that the structure will not disintegrate under the conditions in which the coated structure, such as a catalyst, will be used. The fibre may comprise one or more of the group comprising ceramic fibres, glass fibres, and fibres of metal or metal alloy. In one embodiment a fibre of metal or metal alloy may be used, typically rapidly solidified metal fibres. In another embodiment, the fibres may comprise stainless steel, such as stainless steel AISI 310, AISI 316, or AISI 430. In further embodiments, the fibre comprises, for example, one or more of iron, copper, nickel, molybdenum, and aluminium. In yet another embodiment, the nature of the fibre is selected to contribute to the catalytic activity of the final catalyst.

The fibre has an diameter or equivalent diameter in the range of 5-300 microns. If the diameter or equivalent diameter is too low, the strength of the coated structure will be detrimentally affected. On the other hand, above a certain value any increase of the diameter or equivalent diameter will not contribute to the properties of the coated structure, but will continue to add to the weight and the costs. The diameter or equivalent diameter can be measured visually, where necessary with a microscope or other magnifying apparatus, or using measuring apparatus known in the art, such as a slide calliper.

When a plurality of fibres are present in the coated structure, the average diameter of the fibres can be calculated from the measured diameter or equivalent diameter of at least 2, typically 10, more typically 100 fibres.

In the discussion of embodiments below, it will be apparent that numerical ranges, values and other features of a single fibre in the coated structure having a fibre (equivalent) diameter, length over (equivalent) diameter ratio and a fibre length, will also be applicable to a coated structure comprising a plurality of fibres, having an average fibre diameter, average length over diameter ratio and average fibre length or vice versa.

In a preferred embodiment, the diameter or equivalent diameter of the fibre is at least 20 microns, more preferably at least 25 microns, still more preferably at least 50 microns. Additionally or alternatively, the average diameter of the fibre is preferably at most 200 microns, more preferably at most 150 microns.

The fibre has a length over diameter ratio, or length over equivalent diameter ratio, greater than 500. Preferably, the fibre has a length over diameter ratio, or length over equivalent diameter ratio, of at least 1000, more preferably at least 5000, even more preferably at least 10000. This value, which will also be indicated as the aspect ratio, is defined as the length of the fibre (or average length for a plurality of fibres as defined above), divided by the diameter or equivalent diameter of the fibre (or average diameter for a plurality of fibres as defined above).

The fibre may have a circular circumference, or a non-circular circumference. It may, for example, have a flattended circular circumference, e.g. an oval circular circumference, it may have a square circumference or a rectangular circumference, or any other circumference with round or sharp edges. For the current invention, the diameter of a fibre that does not have a circular circumference is its equivalent diameter. A person skilled in the art may use the common equations to calculate the equivalent diameter.

The equivalent diameter of a rectangular circumference, for example, can be calculated as follows.

dₑ=1.30*((a*b)^{0.625}/(a+b)^{0.25})

wherein dₑ=equivalent diameter in mm; a=length of major side in mm; b=length of minor side in mm.

The equivalent diameter of a fibre with an oval shaped, or ellipse, circumference, for example, may be calculated as follows.

dₑ=1.55A^{0.625}/P^{0.2}

wherein A=cross-sectional area of oval fibre in m²; and p=perimeter of oval fibre in m; A=Πab/4; a=major dimension of the oval; in m b=minor dimension of the oval in m; p≈2Π(½((a/2)²+(b/2)²))^{1/2}

If the aspect ratio is too low, the strength of the coated structure may be insufficient, particularly for use as a catalyst substrate. In a preferred embodiment, the fibre has an aspect ratio of at least 750, more preferably at least 1000, still more preferably at least 10000. The fibre present in the coated structure preferably has a length of greater than 50 mm. If the length of the fibre is below 50 mm, the strength of the structure will be detrimentally affected. In one embodiment, the fibre has an average length of at least 100 mm, more preferably at least 500 mm, still more preferably at least 1000 mm.

The fibre length can be calculated from the fibre density, mass and (equivalent) diameter. The density of the fibre will be known from the fibre material. The fibre diameter can be measured as discussed above and the mass of the fibre measured, for instance on a scale. The fibre length, l, can then be calculated, assuming a cylindrical structure, using the formula:

$$l = \frac{m}{0.25 ρπ {d}^{2}}$$

wherein m is the mass of the fibre, ρ is the density of the fibre, and d is the (equivalent) diameter of the fibre.

Where an average diameter and an average fibre mass are measured for a plurality of fibres, the equation allows the calculation of the average fibre length.

As the presence of small fibres, typically those with a length of less than 50 mm, may detrimentally affect the properties of the coated structure, particularly when used as a catalyst substrate, it may be preferred for less than 10%, determined by number, of the fibres in the structure to have a length below 50 mm. More in particular it may be preferred for less than 5%, determined by number, of a plurality of fibres in the structure to have a length below 50 mm, or even less than 2%.

In one embodiment, the difference in length between a plurality of fibres is relatively small. This is because this will ensure a more homogeneous structure. Therefore, in one embodiment at least 50% by number of a plurality of fibres have a length within 20% of the average fibre length. More in particular, at least 70% by number of a plurality of fibres have a length within 20% of the average fibre length, or at least 80%, or even at least 90%.

At least a portion of the fibre of the coated structure has a coating deposited thereon, the coating comprising a carrier material or a precursor of the carrier material. The carrier material may be an oxidic material, typically an oxide, such as one or more oxides selected from alumina, silica, zirconia, titania, gallia, ceria, and molecular sieves.

A further material or a precursor of the further material may also be deposited on the coated structure. The further material may be a catalytic material, such as one or more of catalytically active metal components of Group VIII, Group VIB, Group VIIB.

In one embodiment, the coated structure, particularly the coating of the coated structure, comprises one or more of catalytically active metal components of Group VIII, Group VIB, Group VIIB or precursors therefor, and oxides selected from alumina, silica, zirconia, titania, gallia, ceria, molecular sieves, and precursors therefor. In particular, the coated structure comprises one or more of catalytically active metals of Group VIII, Group VIB, Group VIIB or precursors therefor. The coated structures disclosed herein can suitably be prepared by the process described below.

The amount of material present on the coated structure may vary within broad ranges. In general, the carrier material and any further material such as a catalytic component makes up at least 0.5 vol. % of the coated structure, optionally after additional heating to provide a heat-treated structure as discussed in detail below. As an upper level, a value of at most 50 vol. % may be mentioned. More in particular, it may make up between 1 and 30 vol. % of the coated structure, still more in particular between 5 and 20 vol. %. The volume of the coated structure is the outer volume.

In one embodiment, the coated structure may comprise 1-20 vol. % of fibre or fibres, in particular 1-10 vol. %, more in particular 3-8 vol. %. Here, the fibre or fibres referred to exclude the carrier material.

The coated structure disclosed herein can have a very high void fraction. In a preferred embodiment, the void fraction is at least 60%, more preferably at least 70%, still more preferably at least 80%, even more preferably at least 85%, most preferably at least 90%. In a preferred embodiment, the structure has a void fraction in the range of 92-97%. An upper limit for the void fraction of 99% may be mentioned. The void fraction is determined from the volume of the coated structure (i.e. the volume of the fibre plus the volume of the fibre coating) as compared to the volume enclosed by the external surface of the coated structure (e.g. the shape into which the fibre is formed, such as a cylinder) using the following formula:

void fraction=[1−(volume of fibre+volume of fibre coating/volume enclosed by the external surface of the coated structure)]*100%

The use of fibres with the specified properties provides coated structures which can have a very large geometric surface area. This makes the structures very suitable for use in catalytic processes where the reaction rate is limited by mass transfer.

In a preferred embodiment, the geometric surface area of the coated structure disclosed herein, optionally after heat treatment to provide a heat-treated structure, is at least 500 m²/m³, more preferably at least 1000 m²/m³. The upper limit of the geometric surface area is not critical. Values up to 8000 m²/m³ and more may be obtained.

In one embodiment, the coated structure comprises a core and an outer layer. The fibre density of the outer layer may be lower than the fibre density of the core. It has been found that a coated structure with these features combines a high void fraction with high strength and in particular high attrition resistance. These properties are desirable for a catalyst substrate. The outer layer is the layer which, on the basis of the cross-section of the structure, makes up the outer 25% of the structure. In this embodiment, the fibre density of the outer layer is at least 10% higher than the fibre density of the core.

The coated structure, optionally after heating to provide a heat-treated structure, generally has a size of at least 0.5 cm³. The maximum size of the coated structure is not critical, and will depend on the application, for instance as a catalyst, and on considerations like ease of handling, size and shape of the unit, etc. As a maximum value a size of 5 m³ may be mentioned.

In one embodiment, the coated structure has a volume in the range of 0.5-200 cm³. Structures within this volume range may be used as catalyst substrates, for example in the manufacturing of fixed bed or moving bed catalyst particles.

In another embodiment, the coated structure has a volume in the range of 200 cm³ to 5 m³. For coated structures forming shaped reactor filling substrates, a volume range of 0.05-5 m³ may be mentioned.

In one embodiment, the fibre or fibres have a rough surface structure, e.g., on the microscopic scale. This makes for improved adhesion of the carrier material and any catalytic component to the fibre.

In one embodiment, the fibre or fibres are rapidly solidified metal fibres. It has been found that these fibres combine a suitable surface roughness with suitable length, (equivalent) diameter, and aspect ratio requirements. Rapidly solidified metal fibres are known in the art. They are produced for example via a process in which a rotating wheel is brought into contact with liquid metal, for example by plunging it into a pool of molten metal or contacting it with the molten tip of a metal rod. The wheel is wetted by the liquid metal. The fibres separate from the wheel through centrifugal forces. Methods for manufacturing metal fibres through rapid solidification processes are known in the art. They are for example described in U.S. Pat. No. 5,027,886, DE 19711764, and DE 10000097. The rapid solidification process can take place in an inert gas environment, e.g. in nitrogen, or in a non-inert environment, e.g., in air. Suitable rapidly solidified metal fibres can be obtained commercially from, in al., Fraunhofer and Fibretech. Alternatively the fibre or fibres may be a metal or metal alloy wool, such as steel wool.

The catalyst described herein formed from the coated structure is especially suitable for use in diffusion-limited reactions most especially the Fischer-Tropsch reaction, but also hydrocracking, oxidative desulphurisation, denox, flameless combustion, alkylation, and hydrotreating, including hydrogenation, hydrodesulphurisation, hydrodentitrogenation, hydrodemetallistaion, and hydrodearomatisation.

Catalysts for use in the Fischer-Tropsch synthesis may comprise the coated structure and one or more metals from Group VIII of the Periodic Table, especially from the cobalt and iron groups, optionally in combination with one or more metal oxides and/or metals as promoters selected from zirconium, titanium, chromium, vanadium and manganese, especially manganese and optionally one or more metals as promoters selected from zirconium, titanium, chromium, vanadium and manganese. A Fischer-Tropsch catalytically active metal or precursor may include a metal such as cobalt, iron, nickel and ruthenium, more preferably cobalt. The catalytically active metal may be present in the catalyst together with one or more metal promoters or co-catalysts. The promoters may be present as metals or as the metal oxide, depending upon the particular promoter concerned. Suitable promoters include oxides of metals from Groups IA, IB, IVB, VB, VIIB and/or VIIB of the Periodic Table, oxides of the lanthanides and/or the actinides. More particularly, the catalyst comprises at least one of an element in Group IVB, VB and/or VIIB of the Periodic Table, in particular titanium, zirconium, manganese and/or vanadium. As an alternative or in addition to the metal oxide promoter, the catalyst may comprise a metal promoter selected from Groups VIIB and/or VIII of the Periodic Table. Particular metal promoters include rhenium, platinum and palladium. A most suitable catalyst comprises cobalt as the catalytically active metal and zirconium as a promoter. Another most suitable catalyst comprises cobalt as the catalytically active metal and manganese and/or vanadium as a promoter.

Catalysts suitable for use in hydrocracking comprising the coated structure often comprise as catalytically active metal or precursor one or more metals selected from Groups VIB and VIII of the Periodic Table of Elements as well as carrier material. More particularly, the hydrocracking catalysts contain one or more noble metals from Group VIII. Still more particularly, the noble metals are platinum, palladium, rhodium, ruthenium, iridium and osmium. Most particularly, catalysts for use in the hydrocracking stage are those comprising platinum. The hydrocracking catalyst may be provided with alumina, silica, silica-alumina, or titania as carrier material. A hydrocracking catalyst may combine a catalytically active metal as described above with a molecular sieve, for example a zeolite, for a particular example a Y zeolite.

For alkylation the catalyst comprising the coated structure may, for example contain as catalytically active material a molecular sieve, which is also a carrier material, for example one or more of zeolite Y, zeolite beta, or ZSM-5, optionally in combination with an active metal component.

For hydrotreating of hydrocarbon feeds, encompassing one or more of hydrogenation, hydrodesulphurisation, hydrodenitrogenation, hydrodemetallisation, or hydrodearomatisation, a suitable catalyst comprising the coated structure may encompass an oxidic carrier as carrier material, for example comprising silica, alumina, titania, or combinations thereof, in particular alumina, in combination with an active metal component comprising a combination of a Group VIB metal component, in particular molybdenum and/or tungsten, more in particular molybdenum, with a Group VIII non-noble metal component, in particular cobalt and/or nickel.

For denox a suitable catalyst comprising the coated structure may comprise vanadium a catalytically active material and titania as carrier material.

In one embodiment, the material of the fibre or fibres acts as catalytically active material. For example, for flameless combustion a catalyst may be prepared comprising titania as carrier material on copper fibre. In this case the copper fibre acts as catalytically active material.

In a further aspect, a catalyst comprising a coated or heat-treated structure described above may be used in catalysing a diffusion limited reaction. The diffusion-limited reaction may for example be selected from the Fischer-Tropsch reaction, hydrocracking, oxidative desulphurisation, denox, flameless combustion, and alkylation. It is considered particularly suitable for catalysing Fischer-Tropsch reactions.

In another aspect, a process for performing a diffusion limited reaction wherein a feedstock is contacted under reaction conditions with a catalyst comprising a coated or heat-treated structure as described above is provided.

In a still further aspect, a process for the production of liquid hydrocarbons which comprises providing a feed comprising CO and H₂ to a reactor comprising a Fischer-Tropsch catalyst, the reactor being at reaction temperature and pressure, and withdrawing an effluent from the reactor, the catalyst comprising one or more metals from Group VIII of the Periodic Table metal of Elements, and a coated structure as described above, is provided.

The reactor used in the Fischer-Tropsch process described herein may be an immobilised slurry reactor, an ebullating bed reactor or a multitubular fixed bed reactor, preferably an immobilised slurry reactor.

The Fischer-Tropsch reaction may be carried out at a temperature in the range from 125 to 400° C., in particular 175 to 300° C., more particularly 200 to 260° C. The gaseous hourly space velocity may vary within wide ranges and is typically in the range from 500 to 10000 N1 (gas)/1 (volume of coated structure)/h, more typically in the range from 1500 to 4000 N1/l/h. The hydrogen to CO ratio of the feed as it is fed to the catalyst bed generally is in the range of 0.5:1 to 2:1.

In one embodiment the feed is provided to the reactor in the form of a mixture of hydrogen and CO, for example in the form of a syngas feed. In another embodiment, the hydrogen and CO are provided to the reactor in different streams.

Products of the Fischer-Tropsch synthesis may range from methane to heavy hydrocarbons. For instance, the production of methane is minimised and a substantial portion of the hydrocarbons produced have a carbon chain length of a least 5 carbon atoms. In particular, the amount of C5+ hydrocarbons may be at least 60% by weight of the total product, more particularly, at least 70% by weight, even more particularly, at least 80% by weight, most particularly at least 85% by weight. The CO conversion of the overall process may be at least 50%.

The products obtained via the process described herein can be processed through hydrocarbon conversion and separation processes known in the art to obtain specific hydrocarbon fractions. Suitable processes are for instance hydrocracking, hydroisomerisation, hydrogenation and catalytic dewaxing. Specific hydrocarbon fractions are for instance LPG, naphtha, detergent feedstock, solvents, drilling fluids, kerosene, gasoil, base oil and waxes.

In one embodiment it may be preferred to treat the catalyst described herein with a wax before providing it to the Fischer-Tropsch reactor. Treating the particles with a wax may serve to facilitate handling, transport, and installation of the particles by improving the strength of the particles. The wax may be incorporated into the catalyst by combining the coated or heat-treated coated structure with liquefied wax, e.g., through dipping or impregnation, optionally removing excess wax, and allowing the wax remaining on the particles to solidify. Suitable waxes include those which are substantially non-tacky below a temperature of about 40° C. For more information on this embodiment, reference is made to what is stated in EP 2 000 207.

In a further aspect, a catalytic hydrocracking reaction in which a hydrocarbon feed is contacted under hydrocracking reaction conditions with a catalyst comprising a Group VIII metal component on a coated or heat-treated substrate is provided.

Suitable conditions for the catalytic hydrocracking are known in the art. Typically, the hydrocracking is affected at a temperature in the range of from about 175 to 400° C. Typical hydrogen partial pressures applied in the hydrocracking process are in the range of from 10 to 250 bar.

The process disclosed herein may advantageously be an automated process for the manufacture of a coated structure. In the present context, the term ‘automated’ relates to a manufacturing method which uses control systems, such as numerical control, programmable logic control and/or other industrial control systems to operate machinery carrying out at least the feeding, compressing, contacting and removing steps discussed below, typically in a sequential, continuous manner. Each step can be operated by an electronic and/or mechanical system, typically controlled by a processing unit. The method may be entirely machine controlled and need not require the constant input and/or the continuous monitoring of a human operator.

The process comprises the step of feeding at least one fibre into a mould to provide a body comprising the fibre. The fibre may be fed from a suitable fibre dispenser. For instance, the fibre may be stored wound on a supply package such as a reel. The fibre can be fed from the fibre dispenser directly into the mould.

If a plurality of fibres are supplied to the mould, these can be fed from multiple fibre dispensers, typically supply packages such as reels. Alternatively, the plurality of fibres may be supplied as a bundle of fibres or a roll of fibres or a part thereof may be fed, typically continuously, into the mould. When the plurality of fibres are supplied as bundles of fibres, these can be fed into the mould as multiple bundles. When the mould has a circular cross-section the fibres may be fed from a roll and wound or coiled into the mould. When the fibres are made of steel, rolls of steel wool may be used. Whatever the form of the fibres to be supplied, it should be non-woven.

In collecting a plurality of fibres in the mould to form a body comprising the fibres, care should be taken of the following. It is advisable that the fibres should not be oriented or aligned with one another in the same direction, or only to a limited extent. For this reason, bundles of fibres in the form of non-woven fibre wool may be used.

With the above guidelines the skilled person will be able to select a method of feeding at least one fibre into a mould to form a body comprising the fibre.

The mould may comprise a liquid permeable base. In the context of the method described herein, the term “liquid permeable” means that the base should allow passage of the liquid present in the mixture used in the contacting step discussed below. It will be apparent that the liquid permeable base should provide a barrier to the fibre or fibres forming the body to prevent fibre loss from the mould. The liquid permeable base of the mould may comprise a mesh, such as a wire mesh, more typically a metallic wire mesh.

The mesh may comprise a plurality of pores to allow passage of liquid. Each hole in the mesh may have a surface area of less than or equal to 4 mm² (e.g. dimensions of less than or equal to 2×2 mm for square pores), more preferably less than or equal to 1 mm² (e.g. dimensions of less than or equal to 1×1 mm for square pores), still more preferably less than or equal to 0.25 mm² (e.g. dimensions of less than or equal to 0.5×0.5 mm for square pores).

The mould may further comprise an open side or end through which the fibre or fibres are admitted, which is typically at the opposite side or end of the mould to the liquid permeable base. The mould may further comprise one or more further sides, typically of a solid material, which are more typically liquid impermeable, and can be joined to the liquid permeable base. An advantage of the method disclosed herein is that the size and shape of the mould can be selected to obtain a coated structure which is tailored to a specific use. For example, the size and shape of the mould can be selected so that a coated structure is formed which has a shape fitted to the unit in which it will be used. For example, when a catalyst is to be formed from the coated structure, it may be tailored to encompass spaces for heating or cooling pipes, or it may be tailored to take into account curvature of the reactor.

The size and shape of the mould may also be selected to form coated structures in the shape of mats or mattresses, spheres, cylinders, cubes, blocks, pyramids, donuts, or irregular shapes. For example, when the coated structure forms a catalyst, it can be used in fixed bed or moving bed applications. The use of cylinders may sometimes be preferred for reasons of processing efficiency.

Once the at least one fibre is fed into the mould, the body comprising the fibre is compressed to provide a compressed body comprising entangled fibre. In a preferred embodiment, the compression of the fibre or fibres making up the body may be carried out in such a manner that the volume of the compressed body is at most 90% of the volume of the aggregate before compression. More preferably, the volume of the compressed body is at most 70% of the volume of the aggregate before compression, even more preferablly at most 50%. Preferably the volume of the compressed body is at least 20% of the volume of the body before compression, more preferably at least 30%.

Compression of the body can be carried out by applying pressure onto the body in the mould from one or more sides. It will be evident to the skilled person how this can be effected.

The degree of compression influences the final properties of the coated structure as follows. The higher the degree of compression, the more the compressed fibre or fibres will entangle. This will have a positive influence on the strength of the coated structure, such as a catalyst substrate. On the other hand, if the degree of compression becomes too high, this may detrimentally affect the porosity of the structure. Thus, the degree of compression will have to be selected in balance with the properties of the fibre or fibres. It is within the ability of the skilled person to select an appropriate degree of compression.

The body can be compressed in the mould by a suitably shaped die or in a double belt press, to provide the compressed body. For instance, the compressed body may be in the form of a cylinder, cuboid, sheet, mat or other form. If necessary, the resulting compressed sheet or mat can be cut into predetermined shapes.

The next step in the process described herein is contacting at least a part of the compressed body with a mixture comprising (i) liquid and (ii) carrier material or a precursor of said carrier material to provide a wetted body. It will be apparent that in certain embodiments the mixture may comprise one or both of:

two or more liquids and

two or more carrier materials or precursors of said carrier materials.

The mixture of liquid and carrier material or a precursor thereof can be supplied to the mould, for instance through an open end of the mould, from a mixture supply system, typically a dosing system. Such a dosing system may comprise a mixture tank for the mixture comprising liquid and carrier material in fluid connection with a metering device, which can supply a predetermined amount (by mass or volume) of mixture through a mixture supply system outlet to the body in the mould. The mixture will have a predetermined proportion of liquid and carrier material or precursor thereof.

The mixture of liquid and carrier material or a precursor thereof can additionally or alternatively be sprayed onto the compressed body after removal of the body from the mould. It is also possible to dip the compressed body into the mixture of liquid and carrier material after removal of the body from the mould.

At least a part of the body is contacted with the mixture comprising liquid and carrier material or the precursor thereof thereby wetting at least a part of the body, such as all of the part contacted with the mixture. For instance, at least 50%, preferably at least 80%, even more preferably at least 95% of the body is contacted with the mixture comprising the liquid and the carrier material or a precursor of said carrier material. It will be apparent that the proportion of the body contacted with the mixture may be determined from the volume of free space in the mould (i.e. the internal volume of the mould not occupied by the body) and the volume of mixture applied.

The presence of a liquid permeable base in the mould allows passage of the mixture through the mould and body therein. This fluid flow allows the mixture to penetrate the voids between the fibre or fibres, thoroughly wetting the body. If the base of the mould were not permeable to the liquid in the mixture, air pockets may form between the fibre or fibres in the body as the mould fills with mixture, especially near the base of the mould, lowering the area of contact between the fibre or fibres and the mixture. Providing a liquid permeable base therefore improves the contact between the mixture and body.

If the mould comprises a liquid permeable base, it may be beneficial to use an excess volume of mixture i.e. above the amount necessary to apply the required amount of carrier material or a precursor thereof, in order to compensate for liquid loss by passage directly through the base of the mould. Such liquid can be collected gravitationally below the base of the mould and recycled to the mixture supply system. For instance, at least a 10% excess (by volume) of mixture may be used, more preferably at least a 25% (by volume), still more preferably at least 50% (by volume).

The carrier material in the mixture may be an oxidic material, typically an oxide, such as one suitable for use in catalytic applications, whether as active component, as adhesive component, or as carrier component. Examples of suitable oxides, typically porous oxides, include silica, alumina, titania, zirconia, gallia, ceria, and oxidic components such as molecular sieves.

Precursors of the carrier material are those compounds which can be converted into the carrier material during a subsequent processing step. For instance, if the carrier material is an oxide, such as one suitable for use in catalytic applications, the precursor thereof may be a compound which can be converted into the desired oxide after removal of liquid, optionally with heating, for instance under calcination conditions, e.g., at a temperature of 300-1100 U in the presence of oxygen. Examples of suitable precursors include salts and hydroxides. Suitable precursors will be discussed in more detail below. It will be apparent that carrier materials and their precursors may be used in all kinds of combinations.

To facilitate adhesion of carrier material such as an oxide, or the precursor thereof, the fibre or fibres can be one or both of cleaned and roughened before application of the carrier material e.g. oxide (or precursor) in the mixture. This can be particularly the case when the fibres comprise metal. This is preferably done before the fibre or fibres form the body in the mould.

The carrier material or precursor thereof may be applied to the compressed body as a mixture such as in the form of a solution or dispersion in the liquid. Typically, a solution or dispersion in an alcoholic liquid medium and/or aqueous medium is used. For instance, an aqueous alcoholic liquid medium may be used. The liquid may be applied by pouring it onto at least a portion of the compressed body in the mould, for instance through an open end of the mould, from the mixture supply system.

As indicated above, the carrier material may be a suitable oxidic material, including the oxides known in the art as carrier material for catalysts, such as alumina, silica, titania, zirconia, gallia, ceria, and mixtures and combinations thereof such as silica-alumina, etc. These oxides may further be indicated as carrier oxides, although the term should not be interpreted as limiting.

Suitable precursors for carrier materials such as carrier oxides are known in the art and include salts or (hydr)oxides. For example, a solution or dispersion may be used comprising one or more salts or (hydr)oxides of silicon, zirconium, gallium, caesium, titanium, or aluminium, e.g., aluminium trihydrate, aluminium monohydrate, silicilic acid, titanium lactate, or an ammonium salt of lactic acid titanate chelate, such as Tyzor® obtainable from DuPont.

The use of the combination of a first type of oxidic material in combination with a precursor for a second type of oxidic material is also envisaged. For example, a dispersion may be used comprising a particulate oxidic material, e.g., alumina, silica, titania, or silica-alumina, in combination with a precursor which acts as adhesive for the particulate oxidic material. Examples of precursors which are particularly suitable in this respect include acid-peptised aluminium trihydrate, silicic acid, and compounds like titanium lactate, and an ammonium salt of lactic acid titanate chelate, such as Tyzor® obtainable from DuPont.

Accordingly, in one embodiment of the contacting step, the compressed body is provided with a precursor for a carrier oxide selected from alumina, silica, zirconia, titania, gallia, ceria, or a combination thereof. In another embodiment, the compressed body is provided with an oxide selected from alumina, silica, zirconia, titania, gallia, ceria, or a combination thereof.

In another aspect, further materials or precursors of said further materials may be coated onto the fibre or fibres. The further material or its precursor may be incorporated as part of the mixture used in the contacting step, such that said mixture comprises (i) liquid, (ii) carrier material or a precursor of said carrier material and (iii) further material or a precursor of said further material.

The further material may be a further oxide. The further oxide may encompass a catalytically active oxide, which for the purposes of the present process and coated structure may be divided into a catalytically active metal component such as an oxide of the non-noble metals of Group VIII of the periodic table of elements (CAS Version), more in particular iron, cobalt, and nickel, oxides of metals of Group VIB of the periodic table of elements, more in particular chromium, molybdenum, and tungsten, and oxides of metals of Group VIIB of the periodic table of elements, more in particular manganese and a catalytically active particulate material such as molecular sieves, including zeolites.

The further material may be one or more of the catalytically active metals of Group VIII, Group VIB, Group VIIB or precursors thereof, or oxides selected from alumina, silica, zirconia, titania, gallia, ceria, and molecular sieves. Suitable precursors for further materials are known in the art and include salts or (hydr)oxides of the further materials.

In one embodiment, the further material may be catalytically active material, thereby forming a catalyst after at least removal of the liquid. Suitable catalytically active material may encompass catalytically active metal components, or other catalytically active materials such as molecular sieves, including zeolites.

Suitable catalytically active metal components include (components of) the noble and non-noble metals of Group VIII of the periodic table of elements (CAS Version), more in particular iron, cobalt, nickel, platinum and palladium, metals of Group VIB of the periodic table of elements, more in particular chromium, molybdenum, and tungsten, metals of Group VIIB of the periodic table of elements, more in particular manganese. Suitable molecular sieves for use in the process described herein encompass the molecular sieves known in the art of catalysis. Suitable molecular sieves include ZSM-5 and other ZSM-type sieves, and zeolites like zeolite beta, zeolite X, and zeolite Y. Combinations of various types of materials may also be used.

Catalytically active particulate materials such as molecular sieves may be applied to the compressed body as a further material present in the mixture of the contacting step. In a preferred embodiment a dispersion is used comprising a combination of a particulate molecular sieve and a precursor of a carrier material, such as an oxidic carrier. For example, a dispersion may be used comprising a particulate molecular sieve in combination with a carrier precursor which acts as adhesive for the particulate material. For examples of precursors particularly suitable as adhesives reference is made to what is stated above.

The various materials can be combined in different configurations. In one embodiment, the compressed body is provided with a precursor for a carrier oxide carrier material selected from alumina, silica, zirconia, titania, gallia, ceria, or a combination thereof, whether or not in combination with an oxide selected from alumina, silica, zirconia, titania, gallia, ceria, molecular sieves, or a combination thereof.

In another embodiment, a precursor for a carrier oxide carrier material selected from alumina, silica, zirconia, titania, gallia, ceria, or a combination thereof, is provided, whether or not in combination with an oxide or a precursor therefor of a non-noble metal of Group VIII, of a metal of Group VIB or a metal of Group VIIB.

Contacting at least a part of the compressed body with a mixture comprising (i) liquid and (ii) carrier material or a precursor of said carrier material (and any further material or precursor of said further material) provides a wetted body.

The next step in the method described herein is the removal of liquid from the wetted body to provide a coated structure. The coated structure comprises entangled fibre with the carrier material or the precursor of the carrier material, together with any optional further material or precursor of the further material, deposited on at least a portion of said fibre.

The liquid removal step removes a part, typically a substantial part, more typically at least 50 wt. %, still more typically at least 70 wt. %, most typically at least 90 wt. % of the liquid from the wetted body.

As part of the liquid removal step, excess carrier material or a precursor of said carrier material and any optional further material or a precursor of said further material may also be removed i.e. the liquid removal step may encompass removal of excess mixture from the wetted body.

In such a case, the base of the mould may be permeable to both the liquid and the carrier material or its precursor and any further material or its precursor. For instance, the carrier material (or a precursor thereof) and/or any further material or precursor thereof may be present in the mixture in solid phase, such as when the mixture is a slurry rather than solution. If the liquid permeable base of the mould is a mesh comprising a plurality of pores, the pores can be of a sufficient size to permit passage of the solid phase.

It may be desirable to remove excess mixture if large quantities have gathered at the fibre intersections of the body. In addition, some of the mixture may be removed from the wetted body when the amount of mixture applied in a single contacting step is more than required such that an excess may result in subsequent problems, such as during a drying stage.

Liquid removal may be achieved by purging liquid and optionally associated carrier or a precursor thereof and optionally further material or a precursor thereof through the liquid permeable base of the mould holding the wetted body. The liquid permeable base may have an upper surface which is adjacent to the wetted body and an opposing lower surface. The liquid removal may be achieved by liquid removal means, such as one or more blowers, jets and pumps. In one embodiment, the liquid removal step can be carried out by passing a gas, typically air or an inert gas such as nitrogen, through the wetted body in the mould. The gas can be supplied by, for instance, an air blower or from one or more jets positioned above and directed toward the base of the mould, with the jets being in fluid communication with a compressor. Liquid (or mixture) from the wetted body may become entrained in the gas passing through the wetted body. The liquid (or mixture) carried by the gas can pass through the liquid permeable base of the mould and be removed.

Alternatively, a reduced pressure (versus the pressure on the upper surface of the liquid permeable base of the mould) may be generated at the lower surface of the liquid permeable base of the mould. Typically, the reduced pressure can be generated a vacuum pump. In this way, liquid and optionally carrier material or the precursor thereof and any further material or the precursor thereof may be sucked from the wetted body through the liquid permeable base of the mould.

The liquid removal step may optionally further comprise subjecting the wetted body to a drying step. In such a drying step, the wetted body may be heated to remove liquid e.g. by evaporation. For instance, the wetted body may be heated at a temperature of 100-200° C. The optional drying step may be carried out for a period of 0.5-48 hours.

Such liquid removal processes are more advantageous than centrifuging to remove the liquid. Centrifuging would require the removal of the wetted body from the mould. This could destabilise the arrangement of the fibre or fibres in the wetted body, and particularly the contact points which will be secured by the carrier material coating, destroying its shape. In addition, utilising the liquid removal processes described herein allows the carrier material or a precursor thereof to be kept in a more even layer on the body compared to centrifuging. Consequently, the contacting step may be repeated fewer times to obtain the desired amount of carrier material or precursor thereof on the fibre compared to a method using a centrifuging step. In this way, liquid can be removed from the wetted body while still in the mould as part of a manufacturing process, especially an automated manufacturing process, and a coated structure produced.

In the context of the present specification the word ‘coated’ should not be interpreted as requiring that the entire surface of all the fibre or fibres is provided with the carrier material or a precursor thereof. This will be apparent because the contacting step requires only that a part (at least) of the body be contacted with the mixture.

Removing liquid from the wetted body may ensure sufficient cohesion between the fibres, as a result of the deposited carrier material or precursor thereof, to allow removal of the coated structure from the mould. The deposited carrier material or precursor thereof may thus act to bind the fibre or fibres where they come into contact. In one aspect, such a coated structure can be used directly as a catalyst substrate or catalyst.

However, it may be desirable to subject the coated structure to a heating step, as this will improve the cohesion between the fibre or fibres. The heating step can provide a heat-treated coated structure. In the present context, the term ‘heat-treated’ is intended to represent a coated structure which has been heated, such as in a calcining or reducing operation. Such heat-treatment may harden the coating of the carrier material and/or convert a precursor of a carrier material to the carrier material.

The heating step may be carried out either before or after the coated structure is removed from the mould. The temperature of the heating step may be up to 1100° C. The heating step may be a calcination operation. Suitable calcination conditions include a temperature of 200-900° C., in particular 450-900° C. in air for a period of 0.5-10 hours.

If the heating step is carried out while the coated structure is still in the mould, the mould may be transferred to a suitable heating device, such as furnace, and the thus obtained heat-treated coated structure may then be removed from the mould. Alternatively, it is also possible to remove the coated structure from the mould, and subject it to a heating step after removal from the mould. The latter operation may be carried out for instance when a heating, and more particularly calcining operation, is to be carried out which exceeds the temperature limit of the mould. In a further aspect, the heat-treating step may be carried out in a reducing atmosphere. Heating under a reducing atmosphere may activate the coated structure as a catalyst. This may be carried out during manufacture or in situ for the intended use of the coated structure, for instance in a catalytic reactor.

In a further aspect, the steps of contacting at least a part of the compressed body with a mixture comprising (i) a liquid and (ii) a carrier material and a precursor thereof, and removing liquid (optionally with a drying operation) may be carried out more than once. In this way, multiple coating layers of carrier material or a precursor thereof (and optionally any further material or a precursor thereof) may be built up on the fibre. However, prior to carrying out any second or further contacting and liquid removal steps, an intervening heating step may be required in order to ensure the adhesion of the previously-applied coating before additional or further carrier material is applied.

For instance, the repetition of these steps allows the control of the thickness of the carrier material or precursor thereof deposited on the fibre or fibres, with each repetition providing a thicker coating. It will be apparent that it is advantageous to repeat these steps while the heat-treated coated structure remains in the mould, in order to better control the contacting of the heat-treated coated structure with the mixture comprising the liquid and carrier material or precursor thereof.

As will be clear to the skilled person, all kinds of other sequential coating treatments are possible, typically with an intermediate heating step being carried out to secure each coating layer.

In another aspect, further materials may be incorporated into the heat-treated coated structure. The further material may be chosen from those further materials which may be incorporated as part of the contacting step discussed above. The further material may be the same or different to any further material which may have been present in the mixture of the contacting step. The further material may be incorporated into the heat-treated coated structure i.e. after the heating of the coated structure, whether before of after removal from the mould.

The further material may be applied by contacting the heat-treated coated structure with a further mixture comprising (i) liquid and (ii) further material or a precursor of said further material (optionally in combination with (iii) further carrier material or a precursor thereof), to provide a wetted heat-treated coated structure. Any further carrier material may be chosen from those carrier materials which may be incorporated as part of the contacting step discussed above. The further carrier material may be the same or different to any further material present in the mixture of the contacting step.

The liquid used in the application of the further material may be chosen from those liquids discussed above as being present in the mixture contacted with the body. The liquid may be the same as or different to the liquid in the mixture contacted with the body.

In one aspect, the further mixture may be in the form of an aqueous solution or dispersion of the further material or a precursor of said further material, optionally in combination with carrier material or a precursor of said carrier material. The mixture can be supplied from a further mixture supply system, in an analogous manner to the contacting of at least part of the body with a mixture from a mixture supply system.

The contacting with the mixture comprising the further material may be followed by subjecting the wetted heat-treated coated structure to a liquid removal step to provide a further coated heat-treated structure comprising the fibre or fibres, carrier material or the precursor of said carrier material (from the previous contacting step(s)) and further material or the precursor of said further material (optionally in combination with any further carrier material or a precursor thereof). The further coated heat-treated structure may then undergo an optional drying step and further heating step such as that discussed above for the coated structure, such as calcination or reduction, for instance to convert a further material precursor into a catalytically active material.

The further material such as a catalytically active metal component will generally be applied in an aqueous solution or dispersion of a salt of a catalytically active metal component precursor, followed by removal of the liquid, e.g. the aqueous medium. The coated structure or heat-treated coated structure provided with the aqueous medium may then be subjected to a heating step which optionally, depending on the nature of the metal, may include a calcination and/or reduction step. The heating step, such as a calcination step, can be performed, for example, at a temperature of 300-700° C., at which the metal salt is converted to the metal oxide. A simultaneous or subsequent reduction step may convert the metal component to its metallic form.

As indicated above, the various components can be applied simultaneously, for example by combining a further material or precursor thereof, such as catalytically active materials or precursors, with the carrier material or precursor thereof when they are applied onto the fibres.

However, especially where a catalytically active metal component is used, it is sometimes preferred for reasons of process control, to first provide the body with a carrier material such as an oxidic material, and then, after a heat-treatment, provide the heat-treated coated structure with the catalytically active metal component or precursor thereof, for example via impregnation. Impregnation may be achieved by contacting the heat-treated coated structure with a solution of the catalytically active metal component or a precursor thereof, such as an aqueous solution of a water soluble salt of the catalytically active metal. This allows the heat-treated coated structure to be wetted with the catalytically active metal component or its precursor and any pores, particularly those of the carrier material, to be filled with the solution. The solvent, such as water, can then be removed to deposit the catalytically active metal component or its precursor on the heat-treated coated structure, particularly on the carrier material, more particularly in the pores of the carrier material. If necessary, the heat-treated coated structure containing the deposited catalytically active metal component or precursor can then be further heat-treated, for instance by calcining or reduction, to convert the catalytically active metal component or precursor into its catalytically active form.

Embodiments of the present invention will now be described by way of example only and with reference to the accompanying non-limited drawing.

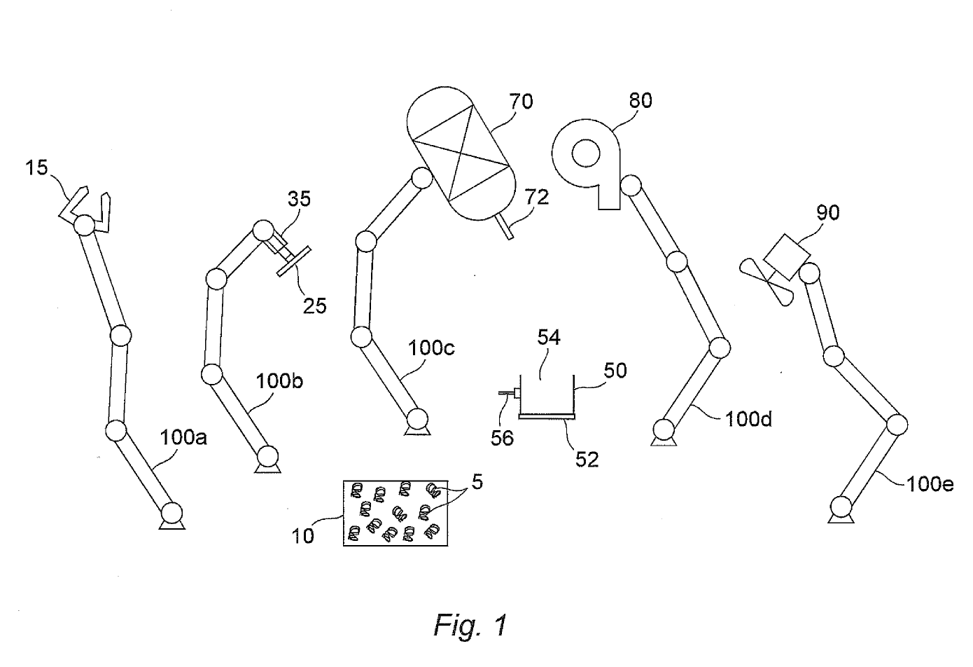

Referring to the drawing, FIG. 1 shows one embodiment of the process described herein, more particularly an automated process. In this embodiment, a mould 50 comprising a liquid permeable base 52 and open end 54 is held stationary by securing means 56, such as a clamp, while one or more robotic arms 100a, b, c, d, e feed fibre bundles 5 form fibre container 10 to the mould 50; and bring mixture supply system such as dosing system 70 comprising mixture supply system outlet 72; gas blower 80 and heating fan 90 into alignment with an open end 54 of the mould 50. This allows each stage of the process to be carried out as described above.

For instance, a fibre container 10 is provided filled with fibre bundles 5. The fibre bundles 5 are picked up with pincers 15 on robotic arm 100a and fed to the mould 50 through open end 54 to form a body comprising the fibre or fibres of the fibre bundles 5. The liquid permeable base 52 of the mould 50 may be a mesh comprising a plurality of pores which are sized to prevent passage of the fibre bundles 5 and any individual fibres, while allowing passage of liquid, namely the liquid of the mixture discussed below.

In an alternative embodiment not shown in FIG. 1, the fibre may be fed to mould 50 from a reel or spool. In such a case, a robotic arm may hold a feeding means for drawing and directing the fibre into the mould, such as a pair of rollers at least one of which is driven to grip and feed a fibre continuously to the mould. The feeding means may further comprise a cutting means such as one or more blades to sever the fibre once a predetermined amount has been fed to mould 50 to form a body comprising the fibre.

Returning to FIG. 1, once a body comprising one or more of the fibre bundles is formed in mould 50, the mould 50 containing the body is compressed. In the embodiment of FIG. 1 the compression is carried out using a press block 25 attached to a robotic arm 100b via a pneumatic actuator 35. The press block 25 engages with the open end 54 of mould 50 and applies a downwards force onto the body comprising the fibre in the mould 50 when the pneumatic actuator 35 is activated, thereby compressing it to form a compressed body. The press block 25 should have a cross-section complementary to that of the open end 54 of the mould 50, such that it can enter the mould 50 through the open end 54 and move within it, reducing the internal volume of the mould 50. For instance, the mould 50 may provide a cylindrical internal volume into which the fibre is fed as one or more bundles 5 to form the body, with one circular end forming liquid permeable base 52 and another circular end 54 being open. The press block 25 may be cylindrical in shape with a circular cross-section smaller than that of the circular cross-section of the open end of the mould 50. Typically, the block will have a cross-section having a close fit with that of the open end of the mould 50.

After compression of the body comprising the fibres to provide a compressed body comprising an entangled fibre or fibres, a mixture supply system 70 is brought into alignment with the open end 54 of the mould 50 by robotic arm 100c. The mixture supply system 70 may be a dosing system comprising a supply of a mixture comprising liquid and carrier material to be contacted with the compressed body, and can be stored in a mixture tank (not shown). The mixture tank is in fluid connection with a metering device, which can supply a predetermined amount (by mass or volume) of mixture to the compressed body in the mould 50. The mixture is delivered to the mould 50, for instance from the metering device, via a mixture supply system outlet 72, which can be positioned gravitationally above an open end 54 of the mould 50 by movement of robotic arm 100c. Depending upon the quantity of mixture supplied to the mould 50 from mixture supply system 70, all or only a part of the compressed body may be contacted with the mixture. It will be apparent that the degree of contacting may depend upon the volume of free space present in the mould 50 (i.e. the total internal volume of the mould minus the total volume of the compressed body) and the volume of mixture added.

When the mixture is added to the open end 54 of mould 50, it will flow through the mould, contacting the compressed body comprising the entangled fibre or fibres as it is drawn by gravity towards the liquid permeable base 52 of the mould. The mixture will contact the compressed body to provide a wetted body. Liquid not retained by the body may exit the mould 50 through the liquid permeable base 52.

Carrier material or a precursor thereof present with the liquid may also pass through the base of the mould if this is also permeable to the carrier material or its precursor. This can occur if, for instance, the carrier material or its precursor is in solution dissolved in the liquid, or if the carrier material or its precursor is in particulate form suspended in the liquid and the liquid permeable base 52 comprises pores of sufficient size to allow passage of the particulate form carrier material or precursor thereof.

The liquid and/or carrier material or a precursor thereof passing though the base 52 of the mould 50 may be collected as spent liquid at a point gravitationally below the liquid permeable base 52 of the mould 50. The spent liquid may then be recycled to the mixture supply system 70, optionally with the addition of fresh carrier material to provide the required carrier concentration in the mixture.

Once the compressed body in the mould 50 has been contacted with the mixture to provide a wetted body, liquid is then removed. In one embodiment shown in FIG. 1, the liquid may be removed by moving one or more gas blowers 80, such as an air blower, into alignment above the open side 54 of the mould 50 using robotic arm 100d, and directing one or more gas streams at the wetted body in the mould 50.

One or more gas streams, such as air streams, from the gas blowers 80, which are typically provided gravitationally above the mould 50, may enter the open end 54 of the mould 50, and pass through the wetted body, thereby entraining liquid and optionally carrier material or a precursor thereof from the mixture wetting the compressed body. The liquid entrained in the gas stream passes through the liquid permeable base 52, such as a mesh, of the mould 50. Carrier material or its precursor may also pass through the liquid permeable base 52 of the mould 50 as discussed above. Typically, this liquid and optionally carrier material or a precursor thereof can be collected as spent liquid and recycled to the dosing system 70, as discussed for the contacting step.

As part of the step of liquid removal from the wetted body, the wetted body in the mould may also be dried. In the embodiment shown in FIG. 1, robotic arm 100e conveys one or more heaters, such as heating fan 90 into alignment above the open side 54 of the mould 50. The one or more heaters can heat the wetted body to remove any remaining liquid, for instance by evaporation, to provide a coated structure comprising the entangled fibre or fibres and the carrier material or the precursor of the carrier material deposited on at least a portion of the fibre or fibres.

The coated structure may then be removed from mould 50. Although not shown in FIG. 1, the coated structure may optionally be conveyed to a heating stage, for instance a furnace or belt calciner, in which the coated structure is heated, typically calcined, to provide a heat-treated coated structure.

The person skilled in the art will understand that the present invention can be carried out in many various ways without departing from the scope of the appended claims.

What is claimed is:

1. A process for manufacturing a catalyst support, which comprises at least the steps of:
feeding at least one fibre into a mould to provide a body comprising the fibre, said fibre having a diameter or equivalent diameter in the range of 5-300 microns, and a length over diameter ratio, or length over equivalent diameter ratio, greater than 500;
compressing the body in the mould to provide a compressed body comprising entangled fibre;
contacting at least a part of the compressed body with a mixture comprising (i) liquid and (ii) carrier material or a precursor of said carrier material to provide a wetted body; and
removing liquid from the wetted body to provide a catalyst support comprising the entangled fibre and the carrier material or the precursor of said carrier material deposited on at least a portion of said fibre.

2. A process according to claim 1, wherein the volume of the compressed body is at most 90% of the volume of the body before compression and at least 20% of the volume of the body before compression.

3. A process according to claim 1, wherein the fibre has a length of greater than 50 mm.

4. A process according to claim 1, wherein the carrier material is a metal oxide or a precursor thereof, selected from one or more of the group consisting of zirconia, gallia, ceria, titania, silica, alumina, a molecular sieve and their precursors.

5. A process according to claim 1, wherein the fibre is selected from one or more of the group consisting of ceramic fibre, glass fibre, metal fibre, metal alloy fibre and combinations thereof.

6. A process according to claim 1, wherein the diameter or equivalent diameter of the fibre is at least 20 microns and at most 250 microns.

7. A process according to claim 1, wherein the fibre has a length over diameter ratio, or length over equivalent diameter ratio, of at least 1000.

8. A process for manufacturing a catalyst, which comprises at least the steps of:
feeding at least one fibre into a mould to provide a body comprising the fibre, said fibre having a diameter or equivalent diameter in the range of 5-300 microns, and a length over diameter ratio, or length over equivalent diameter ratio, greater than 500;
compressing the body in the mould to provide a compressed body comprising entangled fibre;
contacting at least a part of the compressed body with a mixture comprising (i) liquid and (ii) carrier material or a precursor of said carrier material to provide a wetted body; and
removing liquid from the wetted body to provide a catalyst support comprising the entangled fibre and the carrier material or the precursor of said carrier material deposited on at least a portion of said fibre;
impregnating the obtained catalyst support with a catalytically active metal or a precursor of said catalytically active metal.

9. A process according to claim 8, wherein the catalytically active metal or precursor for said catalytically active metal is selected from the group consisting of cobalt, iron, nickel or ruthenium.

10. A process according to claim 8, wherein the volume of the compressed body is at most 90% of the volume of the body before compression and at least 20% of the volume of the body before compression.

11. A process according to claim 8, wherein the fibre has a length of greater than 50 mm.

12. A process according to claim 8, wherein the carrier material is a metal oxide or a precursor thereof, selected from one or more of the group consisting of zirconia, gallia, ceria, titania, silica, alumina, a molecular sieve and their precursors.

13. A process according to claim 8, wherein the fibre is selected from one or more of the group consisting of ceramic fibre, glass fibre, metal fibre, metal alloy fibre and combinations thereof.

14. A process according to claim 8, wherein the diameter or equivalent diameter of the fibre is at least 20 microns and at most 250 microns.

15. A process according to claim 8, wherein the fibre has a length over diameter ratio, or length over equivalent diameter ratio, of at least 1000.

16. A process for manufacturing a catalyst, which comprises at least the steps of:
feeding at least one fibre into a mould to provide a body comprising the fibre, said fibre having a diameter or equivalent diameter in the range of 5-300 microns, and a length over diameter ratio, or length over equivalent diameter ratio, greater than 500;
compressing the body in the mould to provide a compressed body comprising entangled fibre;
contacting at least a part of the compressed body with a mixture comprising (i) liquid, (ii) carrier material or a precursor of said carrier material and (iii) a catalytically active metal or a precursor of said catalytically active metal to provide a wetted body; and
removing liquid from the wetted body to provide a catalyst comprising the entangled fibre, the carrier material or the precursor of said carrier material and the catalytically active metal or the precursor of said catalytically active metal deposited on at least a portion of said fibre.

17. A process according to claim 16, wherein the volume of the compressed body is at most 90% of the volume of the body before compression and at least 20% of the volume of the body before compression.

18. A process according to claim 16, wherein the fibre has a length of greater than 50 mm.

19. A process according to claim 16, wherein the carrier material is a metal oxide or a precursor thereof, selected from one or more of the group consisting of zirconia, gallia, ceria, titania, silica, alumina, a molecular sieve and their precursors.

20. A process according to claim 16, wherein the fibre is selected from one or more of the group consisting of ceramic fibre, glass fibre, metal fibre, metal alloy fibre and combinations thereof.

21. A process according to claim 16, wherein the diameter or equivalent diameter of the fibre is at least 20 microns and at most 250 microns.

22. A process according to claim 16, wherein the fibre has a length over diameter ratio, or length over equivalent diameter ratio, of at least 1000.
